(19) United States
(12) Patent Application Publication
(10) Pub. No.: US 2024/0117244 A1
(43) Pub. Date: Apr. 11, 2024

(54) METHOD

(71) Applicant: Sumitomo Chemical Co., Ltd., Tokyo (JP)

(72) Inventors: Ruth Pegington, Godmanchester (GB); Jonathan Behrendt, Godmanchester (GB)

(21) Appl. No.: 18/467,380

(22) Filed: Sep. 14, 2023

(30) Foreign Application Priority Data
Sep. 15, 2022 (GB) 2213553.7

(51) Int. Cl. C09K 11/02; C09K 11/06

(52) U.S. Cl. CPC C09K 11/025; C09K 11/06; C09K 2211/14

(57) ABSTRACT

A method of treating a reaction mixture comprising light-emitting nanoparticles formed upon reaction of a silica-forming compound in the presence of a light-emitting material in a protic, water-miscible solvent. The method comprises forming a phase-separated system comprising: an aqueous phase comprising the protic, water miscible solvent, an organic phase comprising an organic solvent and a separating solvent; and separating the organic phase. The separating solvent is immiscible with water, miscible with the water-miscible protic solvent and miscible with the organic solvent.

### RELATED APPLICATIONS

This application claims priority to United Kingdom Patent Application GB 2213553.7, filed Sep. 15, 2022, the contents of which are incorporated herein by reference.

### BACKGROUND

The present disclosure provides a method of forming light-emitting nanoparticles.

Nanoparticles of silica and a light-emitting material have been disclosed as labelling or detection reagents.

WO 2018/060722 discloses composite particles comprising a mixture of silica and a light-emitting polymer having polar groups.

WO2022/079005 discloses purification of light-emitting silica nanoparticles using a desalting column.

US2014/039166 discloses a silica nanoparticle for diagnostic imaging which encapsulates an organic fluorescent dye and a metal complex, wherein a ligand of the metal complex form a covalent bond with constituent molecules of the silica nanoparticle.

### SUMMARY

In some embodiments, the present disclosure provides a method of treating a reaction mixture comprising light-emitting nanoparticles formed upon reaction of a silica-forming compound in the presence of a light-emitting material in a protic, water-miscible solvent, the method comprising forming a phase-separated system comprising: an aqueous phase comprising the protic, water miscible solvent, an organic phase comprising an organic solvent and a separating solvent; and separating the organic phase, the separating solvent being immiscible with water, miscible with the water-miscible protic solvent and miscible with the organic solvent.

Optionally, the separating solvent has a dielectric constant between that of the protic, water miscible solvent and the organic solvent.

Optionally, the protic, water-miscible solvent is methanol.

Optionally, the separating solvent is a C₅₋₂₀ alcohol.

Optionally, the light-emitting material has a solubility in the protic, water-miscible solvent of at least 0.05 mg/ml.

Optionally, the light-emitting material is a light-emitting polymer.

Optionally, the silica-forming compound is an orthosilicate compound.

Optionally, the orthosilicate compound is a C₁₋₄ alkylorthosilicate compound.

Optionally, the organic solvent is selected from benzene substituted with one or more substituents; and C₅₋₂₀ alkanes which may be unsubstituted or substituted with one or more substituents selected from F and Cl; and mixtures thereof.

Optionally, substituents of the benzene are selected from C₁₋₆ alkyl, C₁₋₆ alkoxy, F and Cl.

In some embodiments, the present disclosure provides light-emitting nanoparticles obtainable by a method as described herein.

In some embodiments, the present disclosure provides a method of forming light-emitting nanoparticles comprising reacting a silica-forming compound in the presence of a light-emitting material in a protic, water-miscible solvent; forming a two-phase system comprising an aqueous phase, an organic phase comprising a water-immiscible organic solvent and a separating solvent; and separating the organic phase.

### DESCRIPTION OF THE DRAWINGS

The present disclosure is described in conjunction with the appended figures. It is emphasized that, in accordance with the standard practice in the industry, various features are not drawn to scale. In fact, the dimensions of the various features may be arbitrarily increased or reduced for clarity of discussion.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

The invention will now be described in more detail with reference to the drawings wherein:

FIG. 1 is a scanning electron micrograph (SEM) of nanoparticles purified by a comparative method; and

FIG. 2 is a SEM of nanoparticles purified by a method according to an embodiment of the present disclosure.

### DETAILED DESCRIPTION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements. Additionally, the words “herein,” “above,” “below,” and words of similar import, when used in this application, refer to this application as a whole and not to any particular portions of this application. Where the context permits, words in the Detailed Description using the singular or plural number may also include the plural or singular number respectively. The word “or,” in reference to a list of two or more items, covers all of the following interpretations of the word: any of the items in the list, all of the items in the list, and any combination of the items in the list.

The teachings of the technology provided herein can be applied to other systems, not necessarily the system described below. The elements and acts of the various examples described below can be combined to provide further implementations of the technology. Some alternative implementations of the technology may include not only additional elements to those implementations noted below, but also may include fewer elements.

These and other changes can be made to the technology in light of the following detailed description. While the description describes certain examples of the technology, and describes the best mode contemplated, no matter how detailed the description appears, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms.

In the following description, for the purposes of explanation, numerous specific details are set forth in order to provide a thorough understanding of implementations of the disclosed technology. It will be apparent, however, to one skilled in the art that embodiments of the disclosed technology may be practiced without some of these specific details.

Silica nanoparticles containing a light-emitting material may be formed by reacting a silica-forming compound such as an orthosilicate, preferably a tetralkylorthosilicate such as tetraethylorthosilicate (TEOS), in the presence of the light-emitting material to form nanoparticles in which molecules of the light-emitting material are contained, e.g., entrained, within the nanoparticles. Silica formation may be carried out in the presence of one or more light-emitting materials. Preferably, the silica-forming compound is mixed with the light-emitting material so as to form nanoparticles in which the light-emitting material is not covalently bound to the silica. In other embodiments, the light-emitting material is covalently bound to the silica.

To form the nanoparticles, a silicate for formation of silica, preferably a tetraalkylorthosilicate, may be reacted in a solvent comprising or consisting of a protic water miscible solvent such an alcohol, preferably methanol, in the presence of the light-emitting material. Preferably, the light-emitting material is dissolved in the protic, water miscible solvent. The protic, water miscible solvent may contain methanol and optionally, water and/or one or more further solvents which are miscible with the protic, water-miscible solvents, preferably one or more C₄₋₂₀ alcohols which are not water-miscible, such as 1-octanol.

During silica formation the light-emitting material may become entrained within the silica in the case where the light-emitting material is not covalently bound to the silica nanoparticles. The entrained light-emitting material may be resistant to washing out from the nanoparticle when the nanoparticle is suspended in a liquid.

The present inventors have unexpectedly found that silica nanoparticles formed by this process have a reduced tendency to aggregate if treated by a method as described herein. Without wishing to be bound by any theory, molecules of the light-emitting material which have not been entrained in the nanoparticles might be attracted to the surface of the light-emitting nanoparticles and the presence of these surface molecules might enhance the tendency of the nanoparticles to aggregate, and so removal of this free light-emitting material might reduce the degree of nanoparticle aggregation.

Again without wishing to be bound by any theory, the separating solvent may draw free light-emitting material out of the aqueous phase of the two-phase system containing the nanoparticles and into the organic phase.

The method includes forming a two-phase system comprising adding an organic solvent which is immiscible with water to the product mixture comprising the light-emitting nanoparticles formed following reaction of a silica-forming compound in the presence of a light-emitting material, and separation of the resultant organic phase. The method further comprises adding water to the product mixture if not already present in an amount sufficient to form the two-phase system. The method further comprises adding a separating solvent to the product mixture, if not already present in the product mixture, or optionally adding additional separating solvent to the product mixture.

The organic solvent may be any solvent which is immiscible with water at 25° C. and 1 atmosphere pressure. Examples include, without limitation, benzene optionally substituted with one or more substituents, optionally one or more substituents selected from C₁₋₆ alkyl, C₁₋₆ alkoxy, F and Cl; branched, linear or cyclic C₅₋₂₀ alkanes which may be unsubstituted or substituted with one or more substituents selected from F and Cl; carboxylic esters, preferably C₁₋₁₂ alkyl or phenyl acetates; di(C₁₋₁₂ alkyl) ethers; C₁₋₁₂ alkyl-tetrahydrofuran; C₄₋₁₂ ketones; and mixtures thereof. The organic solvent may be more or less dense than water at 25° C. and atmosphere pressure, preferably less dense.

The separating solvent is miscible with the organic solvent; miscible with the protic, water miscible solvent, and immiscible with water at 25° C. and 1 atmosphere pressure. The separating solvent suitably has a dielectric constant between that of the protic, water-miscible solvent and the organic solvent. Exemplary separating solvents are C₅₋₂₀ alcohols, for example 1-octanol.

The water volume in the two-phase system is preferably at least the same as that of the protic, water-miscible solvent, more preferably greater than that of the protic, water-miscible solvent.

The volume of the protic water-miscible solvent in the two-phase system is preferably greater than that of the separating solvent, more preferably at least 2 or at least 3 times greater. The water, the organic solvent and the separating solvent may be added to the reaction mixture simultaneously or sequentially in any order. In a preferred embodiment, water is added prior to addition of the organic solvent. According to this embodiment, phase separation of the separating solvent and removal of the phase-separated separating solvent may be allowed to occur before the addition of the organic solvent to remove residual separating solvent in the aqueous phase. Separation of the organic and aqueous phases may be carried out using any technique known to the skilled person, for example by use of a separating funnel.

Following separation of the organic phase, the resultant nanoparticle dispersion may be treated by any further purification method known to the skilled person including, without limitation, one or more of: vacuum and/or heat treatment, e.g., to remove any residual organic solvents having a boiling point of less than 100 C at atmospheric pressure; dialysis; centrifugation; and size exclusion chromatography, e.g., by use of a desalting column. The present inventors have found that centrifugation of nanoparticles as described herein may result in nanoparticles which are difficult to re-disperse, particularly at small nanoparticle sizes, e.g., a Z average diameter of 50 nm or less. Accordingly, separation of the nanoparticles as described herein preferably does not comprise centrifugation.

Optionally, at least 0.1 wt. % of total weight of the nanoparticle core consists of the light-emitting material and, optionally, one or more further light-emitting materials. Preferably at least 1, 10, 25 wt. % of the total weight of the nanoparticle core consists of one or more light-emitting materials. The nanoparticle core as described herein is the nanoparticle formed following reaction of the silica-forming compound as described herein, and prior to attachment of any surface groups at the silica surface of the nanoparticles.

Optionally at least 50 wt. % of the total weight of the nanoparticle core consists of the silica. Preferably at least 60, 70, 80, 90, 95, 98, 99, 99.5, 99.9 wt. % of the total weight of the nanoparticle core consists of silica.

In some embodiments of the present disclosure, at least 70 wt. % of the total weight of the nanoparticle core consists of the light-emitting material or materials and silica. Preferably at least 80, 90, 95, 98, 99, 99.5, 99.9 wt. % of the total weight of the nanoparticle core consists of the light-emitting material or materials and silica. More preferably the nanoparticle core consists essentially of the one or more light-emitting materials and silica.

Preferably, the light-emitting nanoparticles as described herein have a Z average diameter of no more than 500 nm or 400 nm in methanol as measured by dynamic light scattering (DLS) using a Malvern Zetasizer Nano ZS. Preferably the nanoparticles have a Z average diameter of between 5-500 nm, optionally 5-100 nm, as measured by a Malvern Zetasizer Nano ZS. In a preferred embodiment, the nanoparticles have a Z average of no more than 50 nm.

Light-Emitting Material

The light-emitting material may be polymeric or non-polymeric. Preferably, the light-emitting material is a light-emitting polymer. A light-emitting polymer as described herein comprises a repeating unit in a backbone of the polymer. The light-emitting polymer preferably comprises at least three light-emitting repeat units. The light-emitting polymer may be monodisperse or polydisperse. The polymer chains may all be contained within a surface of the core defined by the silica. One or more light-emitting polymer chains may protrude beyond a surface of the core defined by the silica.

A light-emitting polymer may, due to its typically large size, be less likely to leach out of the nanoparticle when dispersed in a liquid than a non-polymeric light-emitting material. Consequently, the treatment as described herein may preferentially remove light-emitting polymer chains at the surface of the nanoparticles as compared to light-emitting polymer chains dispersed within the nanoparticles.

Light-emitting materials as described herein may emit fluorescent light, phosphorescent light or a combination thereof. Preferably, the light-emitting material is fluorescent.

The light-emitting material may emit light having a peak wavelength in the range of 350-1000 nm.

A blue light-emitting material as described herein may have a photoluminescence spectrum with a peak of no more than 500 nm, preferably in the range of 400-500 nm, optionally 400-490 nm.

A green light-emitting material as described herein may have a photoluminescence spectrum with a peak of more than 500 nm up to 580 nm, optionally more than 500 nm up to 540 nm.

A red light-emitting material as described herein may have a photoluminescence spectrum with a peak of no more than more than 580 nm up to 950 nm, optionally up to 630 nm, optionally 585 nm up to 625 nm.

The light-emitting material may have a Stokes shift in the range of 10-850 nm.

UV/vis absorption spectra of light-emitting markers as described herein may be as measured in methanol solution or suspension using a Cary 5000 UV-vis-IR spectrometer.

Photoluminescence spectra of light-emitting nanoparticles as described herein may be measured in methanol solution or suspension using a Jobin Yvon Horiba Fluoromax-3.

The light-emitting material may be an inorganic light-emitting material; a non-polymeric organic light-emitting material; or a light-emitting polymer.

Exemplary non-polymeric fluorescent materials include, without limitation: fluorescein and salts thereof, for example, fluorescein isothiocyanate (FITC), fluorescein NHS, Alexa Fluor 488, Dylight 488, Oregon green, DAF-FM, 6-FAM2,7-dichlorofluorescein, 3′-(p-aminophenyl)fluorescein and 3′-(hydroxyphenyl)fluorescein; rhodamines, for example Rhodamine 6G and Rhodamine 110 chloride; coumarins; boron-dipyrromethenes (BODIPYs); naphthalimides; perylenes; benzanthrones; benzoxanthrones; and benzothiooxanthrones, each of which may be unsubstituted or substituted with one or more substituents. Exemplary substituents are chlorine, alkyl amino; phenylamino; and hydroxyphenyl.

A light-emitting polymer as described herein may be a homopolymer or may be a copolymer comprising two or more different repeat units.

The light-emitting polymer may comprise light-emitting groups in the polymer backbone, pendant from the polymer backbone or as end groups of the polymer backbone. In the case of a phosphorescent polymer, a phosphorescent metal complex, preferably a phosphorescent iridium complex, may be provided in the polymer backbone, pendant from the polymer backbone or as an end group of the polymer backbone.

The light-emitting polymer may have a non-conjugated backbone or may be a conjugated polymer. Conjugated polymers are preferred.

By “conjugated polymer” is meant a polymer comprising repeat units in the polymer backbone that are directly conjugated to adjacent repeat units. Conjugated light-emitting polymers include, without limitation, polymers comprising one or more of arylene, heteroarylene and vinylene groups conjugated to one another along the polymer backbone.

The light-emitting polymer may have a linear, branched or crosslinked backbone.

The light-emitting polymer may comprise one or more repeat units in the backbone of the polymer substituted with one or more substituents selected from non-polar and polar substituents.

Preferably, the light-emitting polymer comprises at least one polar substituent. The one or more polar substituents may be the only substituents of said repeat units, or said repeat units may be further substituted with one or more non-polar substituents, optionally one or more C₁₋₄₀ hydrocarbyl groups. The repeat unit or repeat units substituted with one or more polar substituents may be the only repeat units of the polymer or the polymer may comprise one or more further co-repeat units wherein the or each co-repeat unit is unsubstituted or is substituted with non-polar substituents, optionally one or more C₁₋₄₀ hydrocarbyl substituents.

C₁₋₄₀ hydrocarbyl substituents as described herein include, without limitation, C₁₋₂₀ alkyl, unsubstituted phenyl and phenyl substituted with one or more C₁₋₂₀ alkyl groups.

As used herein a “polar substituent” may refer to a substituent, alone or in combination with one or more further polar substituents, which renders the light-emitting polymer with a solubility of at least 0.01 mg/ml in an alcoholic solvent. Optionally, solubility is at least 0.05 or 0.1 mg/ml. The solubility is measured at 25° C. Preferably, the alcoholic solvent is a C₁₋₁₀ alcohol, more preferably methanol.

Polar substituents are preferably substituents capable of forming hydrogen bonds or ionic groups.

In some embodiments, the light-emitting polymer comprises polar substituents of formula —O(R³O)ₜ—R⁴ wherein R³ in each occurrence is a C₁₋₁₀ alkylene group, optionally a C₁₋₅ alkylene group, wherein one or more non-adjacent, non-terminal C atoms of the alkylene group may be replaced with O, R⁴ is H or C₁₋₅ alkyl, and t is at least 1, optionally 1-10. Preferably, t is at least 2. More preferably, t is 2 to 5. The value of t may be the same in all the polar groups of formula —O(R³O)ₜ—R⁴. The value of t may differ between polar groups of the same polymer.

By “C₁₋₅ alkylene group” as used herein with respect to R³ is meant a group of formula —(CH₂)_{f}— wherein f is from 1-5.

Preferably, the light-emitting polymer comprises polar substituents of formula —O(CH₂CH₂O)ₜ—R⁴ wherein t is at least 1, optionally 1-10 and R⁴ is a C₁₋₅ alkyl group, preferably methyl. Preferably, t is at least 2. More preferably, t is 2 to 5, most preferably q is 3.

In some embodiments, the light-emitting polymer comprises polar substituents of formula —N(R⁵)₂, wherein R⁵ is H or C₁₋₁₂ hydrocarbyl. Preferably, each R⁵ is a C₁₋₁₂ hydrocarbyl.

In some embodiments, the light-emitting polymer comprises polar substituents which are ionic groups which may be anionic, cationic or zwitterionic. Preferably the ionic group is an anionic group.

Exemplary anionic groups are —COO⁻, a sulfonate group; hydroxide; sulfate; phosphate; phosphinate; or phosphonate.

An exemplary cationic group is —N(R⁵)₃⁺ wherein R⁵ in each occurrence is H or C₁₋₁₂ hydrocarbyl. Preferably, each R⁵ is a C₁₋₁₂ hydrocarbyl.

A light-emitting polymer comprising cationic or anionic groups comprises counterions to balance the charge of these ionic groups.

An anionic or cationic group and counterion may have the same valency, with a counterion balancing the charge of each anionic or cationic group.

The anionic or cationic group may be monovalent or polyvalent. Preferably, the anionic and cationic groups are monovalent.

The light-emitting polymer may comprise a plurality of anionic or cationic polar substituents wherein the charge of two or more anionic or cationic groups is balanced by a single counterion. Optionally, the polar substituents comprise anionic or cationic groups comprising di- or trivalent counterions.

The counterion is optionally a cation, optionally a metal cation, optionally Li⁺, Na⁺, K⁺, Cs⁺, preferably Cs⁺, or an organic cation, optionally ammonium, such as tetraalkylammonium, ethylmethyl imidazolium or pyridinium.

The counterion is optionally an anion, optionally a halide; a sulfonate group, optionally mesylate or tosylate; hydroxide; carboxylate; sulfate; phosphate; phosphinate; phosphonate; or borate.

In some embodiments, the light-emitting polymer comprises polar substituents selected from groups of formula —O(R³O)ₜ—R⁴, groups of formula —N(R⁵)₂, groups of formula OR⁴ and/or ionic groups. Preferably, the light-emitting polymer comprises polar substituents selected from groups of formula —O(CH₂CH₂O)ₜR⁴, groups of formula —N(R⁵)₂, and/or anionic groups of formula —COO⁻. Preferably, the polar substituents are selected from the group consisting of groups of formula —O(R³O)ₜ—R⁴, groups of formula —N(R⁵)₂, and/or ionic groups. Preferably, the polar substituents are selected from the group consisting of polyethylene glycol (PEG) groups of formula —O(CH₂CH₂O)ₜR⁴, groups of formula —N(R⁵)₂, and/or anionic groups of formula —COO⁻. R³, R⁴, R⁵, and t are as described above.

Optionally, the backbone of the light-emitting polymer is a conjugated polymer. Optionally, the backbone of the conjugated light-emitting polymer comprises repeat units of formula (III):

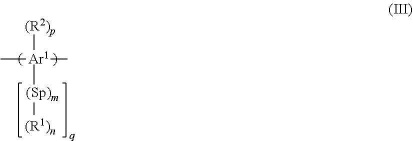

wherein Ar¹ is an arylene group or heteroarylene group; Sp is a spacer group; m is 0 or 1; R¹ independently in each occurrence is a polar substituent; n is 1 if m is 0 and n is at least 1, optionally 1, 2, 3 or 4, if m is 1; R² independently in each occurrence is a non-polar substituent; p is 0 or a positive integer, optionally 1, 2, 3 or 4; q is 0 or a positive integer, optionally 1, 2, 3 or 4; and wherein Sp, R¹ and R² may independently in each occurrence be the same or different. Two substituents of Ar¹ may be linked to form a ring.

Preferably, m is 1 and n is 2-4, more preferably 4.

Preferably p is 0.

Preferably q is at least 1.

Ar¹ of formula (III) is optionally a C₆₋₂₀ arylene group or a 5-20 membered heteroarylene group. Ar¹ is preferably a dibenzosilole group or a C₆₋₂₀ arylene group, optionally phenylene, fluorene, benzofluorene, phenanthrene, naphthalene or anthracene, more preferably fluorene or phenylene, most preferably fluorene.

Exemplary Ar¹ groups of formula (III) include groups of formula (IV)-(X):

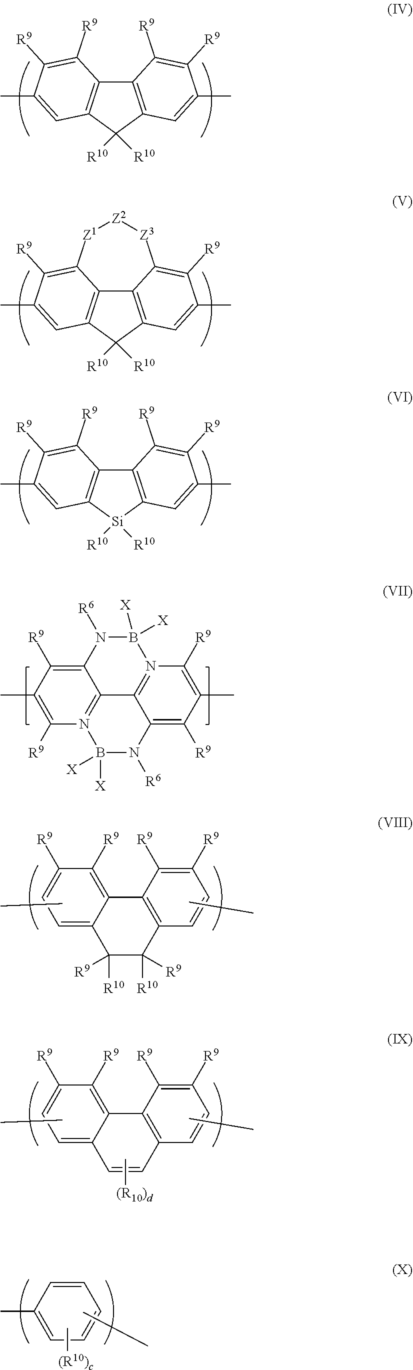

wherein
R⁹ in each occurrence is independently H, R¹ or R², preferably H;
R¹⁰ in each occurrence is independently R¹ or R²; R⁶ is a C₁₋₁₂ hydrocarbyl group, optionally a C₁₋₁₂ alkyl group or C₁₋₄ alkyl group;
c is 0, 1, 2, 3 or 4, preferably 1 or 2;
d is 0, 1 or 2;
X independently in each occurrence is a substituent, preferably a substituent selected from the group consisting of branched, linear or cyclic C₁₋₂₀ alkyl; phenyl which is unsubstituted or substituted with one or more substituents, e.g., one or more C₁₋₁₂ alkyl groups; and F; and
Z¹-Z²-Z³ is a C₂ (ethylene) C₃ alkylene (propylene) chain wherein one or two non-adjacent C atoms may be replaced with O, S or NR⁶.

Sp-(R¹)n may be a branched group, optionally a dendritic group, substituted with polar groups, optionally —NH₂ or —OH groups, for example polyethyleneimine.

Preferably, Sp is selected from:
C₁₋₂₀ alkylene or phenylene-C₁₋₂₀ alkylene wherein one or more non-adjacent C atoms may be replaced with O, S, N or C═O;
a C₆₋₂₀ arylene or 5-20 membered heteroarylene, more preferably phenylene, which, in addition to the one or more substituents R¹, may be unsubstituted or substituted with one or more non-polar substituents, optionally one or more C₁₋₂₀ alkyl groups.

“alkylene” as used herein means a branched or linear divalent alkyl chain.

“non-terminal C atom” of an alkyl group as used herein means a C atom other than the methyl group at the end of an n-alkyl group or the methyl groups at the ends of a branched alkyl chain.

More preferably, Sp is selected from:
C₁₋₂₀ alkylene wherein one or more non-adjacent C atoms may be replaced with O, S or CO; and
a C₆₋₂₀ arylene or a 5-20 membered heteroarylene, even more preferably phenylene, which may be unsubstituted or substituted with one or more non-polar substituents.

R¹ may be a polar substituent as described anywhere herein. Preferably, R¹ is:
a polyethylene glycol (PEG) group of formula —O(CH₂CH₂O)ₜR⁴ wherein t is at least 1, optionally 1-10 and R⁴ is a C₁₋₅ alkyl group, preferably methyl;
a group of formula —N(R⁵)₂, wherein R⁵ is H or C₁₋₁₂ hydrocarbyl; or
an anionic group of formula —COO⁻.

In the case where n is at least two, each R¹ may independently in each occurrence be the same or different. Preferably, each R¹ attached to a given Sp group is different.

In the case where p is a positive integer, optionally 1, 2, 3 or 4, the group R² may be selected from:
alkyl, optionally C₁₋₂₀ alkyl; and
aryl and heteroaryl groups that may be unsubstituted or substituted with one or more substituents, preferably phenyl substituted with one or more C₁₋₂₀ alkyl groups;
a linear or branched chain of aryl or heteroaryl groups, each of which groups may independently be substituted, for example a group of formula —(Ar³)ₛ wherein each Ar³ a is independently an aryl or heteroaryl group and s is at least 2, preferably a branched or linear chain of phenyl groups each of which may be unsubstituted or substituted with one or more C₁₋₂₀ alkyl groups; and
a crosslinkable-group, for example a group comprising a double bond such and a vinyl or acrylate group, or a benzocyclobutane group.

Preferably, each R², where present, is independently selected from C₁₋₄₀ hydrocarbyl, and is more preferably selected from C₁₋₂₀ alkyl; unsubstituted phenyl; phenyl substituted with one or more C₁₋₂₀ alkyl groups; and a linear or branched chain of phenyl groups, wherein each phenyl may be unsubstituted or substituted with one or more substituents.

A polymer as described herein may comprise or consist of only one form of the repeating unit of formula (III) or may comprise or consist of two or more different repeat units of formula (III).

Optionally, the polymer comprising one or more repeat units of formula (III) is a copolymer comprising one or more co-repeat units.

If co-repeat units are present then the repeat units of formula (III) may form between 0.1-99 mol % of the repeat units of the polymer, optionally 50-99 mol % or 80-99 mol %. Preferably, the repeat units of formula (I) form at least 50 mol % of the repeat units of the polymer, more preferably at least 60, 70, 80, 90, 95, 98 or 99 mol %. Most preferably the repeat units of the polymer consist of one or more repeat units of formula (I).

The or each repeat unit of the polymer may be selected to produce a desired colour of emission of the polymer.

Arylene repeat units of the polymer include, without limitation, fluorene, preferably a 2,7-linked fluorene; phenylene, preferably a 1,4-linked phenylene; naphthalene, anthracene, indenofluorene, phenanthrene and dihydrophenanthrene repeat units.

The polystyrene-equivalent number-average molecular weight (Mn) measured by gel permeation chromatography of the light-emitting polymers or the silica polymers described herein may be in the range of about 1×10³ to 1×10⁸, and preferably 1×10⁴ to 5×10⁶. The polystyrene-equivalent weight-average molecular weight (Mw) of the polymers described herein may be 1×10³ to 1×10⁸, and preferably 5×10³ to 1×10⁷.

Polymers as described herein are suitably amorphous polymers.

Surface Groups

Nanoparticles formed by reaction of a silica-forming compound in the presence of one or more light emitting compounds as described herein have a core comprising the silica and the light-emitting material or materials. Following purification of the nanoparticles by the method described herein, one or more surface groups may be bound to silica at the surface of the cores.

Surface groups include, without limitation, surface groups for preventing aggregation of the nanoparticles, surface groups comprising a binding group for binding to a target, and combinations thereof.

Surface groups as described herein may be covalently bound to the silica surface of the nanoparticle core. To form a surface group, the nanoparticles may be brought into contact with a reactive compound for forming the surface group having a reactive group capable of reacting with Si—O groups at the surface of the nanoparticle core. The reactive group may be a group of formula —Si(OR⁷)₃ wherein R⁷ in each occurrence is independently H or a substituent, preferably a C₁₋₁₀ alkyl.

The surface groups may comprise a group of formula (I):

-PG-EG (I)

wherein PG is a polar group bound directly to the surface of the silica nanoparticle core or bound through an attachment group such as a group of formula —O—Si(R⁷)₂—O; and EG is an end group.

PG may be a linear or branched polar group.

PG may comprise heteroatoms capable of forming hydrogen bonds with water, optionally a linear or branched alkylene chain wherein one or more C atoms of the alkylene chain are replaced with O or NR⁶ wherein R⁶ is a C₁₋₁₂ hydrocarbyl group, optionally a C₁₋₁₂ alkyl group or C₁₋₄ alkyl group.

Preferably, PG has a molecular weight of less than 5,000, optionally in the range of 130-3500 Da.

Preferably, PG is a polyether chain. By “polyether chain” as used herein is meant a divalent chain comprising a plurality of ether groups.

Preferably, PG comprises a group of formula (II):

—((CR¹⁴R¹⁵)_{b}O)_{c}— (II)

wherein R¹⁴ and R¹⁵ are each independently H or C₁₋₆ alkyl and b is at least 1, optionally 1-5, preferably 2, and c is at least 2, optionally 2-1,000, preferably 10-500, 10-200 or 10-100, most preferably 10-50.

Most preferably, PG comprises or consists of a polyethylene glycol chain.

In some embodiments, the end group EG is an attachment group for attachment to a probe group capable of binding to a target.

The attachment group may be a biomolecule, e.g., biotin, for attachment through streptavidin, neutravidin, avidin or a recombinant variant or derivative thereof to a biotinylated probe group.

In some embodiments the attachment group may be an amine, a thiol, an azide, dibenzocyclooctyne (DBCO), acetal, tetrazine, carboxylic acid or a derivative thereof such as an amide or ester, preferably an NHS ester, acid chloride or acid anhydride group. The attachment group may be activated before attachment to a probe, e.g., activation of a carboxylic acid group using a carbodiimide, for example EDC.

In some embodiments, the end group EG is not a reactive group for attachment (directly or indirectly) to a probe group. According to these embodiments, EG is optionally selected from H; C₁₋₁₂ alkyl; C₁₋₁₂ alkoxy; and esters, e.g., C₁₋₂₀ hydrocarbyl esters of COOH.

The nanoparticle core may be substituted with different surface groups, e.g., a first surface group for attachment to a probe and a second, inert surface group.

Preferably, the number of second surface groups is greater than the number of first surface groups. Optionally, the number of moles of the second surface groups is at least 2 times, preferably 3 times, more preferably at least 5 times, the number of moles of the first surface groups. Most preferably, the number of first surface groups is less than 10 mol %, optionally up to 5 mol %, of the total number of moles of the first and second surface groups.

Preferably, the number of first surface groups is more than 0.1 mol %, optionally at least 0.5 mol %, of the total number of moles of the first and second surface groups.

The probe may be, without limitation, an antibody; an antigen-binding fragment (Fab); a mimetic, e.g., a minibody, nanobody, monobody, diabody or triabody or affibody; a DARPin; or a fusion protein, e.g., a single-chain variable fragment (scFv); a linear or cyclic peptide; annexin V; RNA or DNA; or an aptamer.

An antibody biomolecule may be selected according to the antigen to be detected. In the case of a biotinylated nanoparticle, wide range of biotinylated antibodies are known and commercially available or may be prepared using techniques known the skilled person as disclosed in, for example, https://www.abcam.com/ps/pdf/protocols/biotin_conjugation.pdf, the contents of which are incorporated herein by reference.

Surface groups may be polydisperse.

The surface groups may have a multimodal weight distribution, optionally a bimodal weight distribution. A multimodal weight distribution may be achieved by mixing polydisperse materials having different average molecular weights.

Colloids

The nanoparticles following treatment as described herein may be in the form of a colloidal suspension comprising the particles suspended in a liquid, preferably water.

The liquid may be a buffer solution. The salt concentration of a buffer solution may be in the range of about 1 mmol/L-200 mmol/L.

The concentration of the nanoparticles in the colloidal suspension is preferably in the range of 0.1-20 mg/mL, optionally 5-20 mg/mL.

In some embodiments, the nanoparticles may be stored as a colloidal suspension, optionally a colloidal suspension having a nanoparticle concentration greater than 0.1 mg/mL, preferably at least 0.5 mg/mL or 1 mg/mL.

Applications

Nanoparticles as described herein may be used as a luminescent probe, e.g., a fluorescent probe for detecting a biomolecule or for labelling a biomolecule or for use in DNA sequencing.

In some embodiments, the nanoparticles may be used as a luminescent probe, e.g., a fluorescent probe in an immunoassay such as a lateral flow or solid state immunoassay. Optionally the nanoparticles are for use in fluorescence microscopy, flow cytometry, next generation sequencing, in-vivo imaging, or any other application where a light-emitting marker configured to bind to a target analyte is brought into contact with a sample to be analysed. The applications can medical, veterinary, agricultural or environmental applications whether involving patients (where applicable) or for research purposes.

Preferably, the presence and/or concentration of a target analyte comprises measurement of any light-emitting markers dispersed or dissolved in the sample which are bound to the target analyte (as opposed to light-emitting markers bound to the target analyte and immobilised on a surface).

Preferably, the presence and/or concentration of a target analyte comprises detection of light emitted directly from the light emitting marker.

In some embodiments, a sample to be analysed may brought into contact with the nanoparticles, for example the nanoparticles in a colloidal suspension.

In some embodiments, the sample following contact with the nanoparticles is analysed by flow cytometry. In flow cytometry, the nanoparticles are irradiated by at least one wavelength of light, optionally two or more different wavelengths, e.g., one or more wavelengths including at least one of 355, 405, 488, 562 and 640 nm. Light emitted by the nanoparticles may be collected by one or more detectors. Detectors may be selected from, without limitation, photomultiplier tubes and photodiodes. To provide a background signal for calculation of a staining index, measurement may be made of nanoparticles mixed with cells which do not bind to the particles.

In some embodiments, e.g., a plate assay, any target antigen in the sample may be immobilised on a surface which is brought into contact with the particles.

### EXAMPLES

Nanoparticle Synthesis

A 500 ml Duran bottle is charged with polymer solution (10 ml, 1 mg/ml solution in methanol), methanol (70 ml), 1-octanol (20 ml) and ammonium hydroxide (5 ml, 28% aq.). The bottle is then closed, and the mixture heated in an oil bath set to 40° C. TEOS (1 ml) is added and the mixture continued to stir for 1 hour, after which an additional TEOS is added (0.6 ml). After hour, the reaction is either purified via desalting method or using extraction method, outlined below.

### Example 1

Water is added to the reaction mixture (100 ml) and the mixture removed from the oil bath and allowed to cool to ambient temperature. The reaction mixture is transferred to a separatory funnel. After phase separation, the aqueous phase is collected into a vessel containing pentane (50 ml). The pentane phase is removed using a separatory funnel and the aqueous phase collected onto pentane (50 ml). Collection onto pentane and separation is repeated. Finally, the aqueous phase is transferred to a flask for rotary evaporation. For each transfer to separatory funnels and vessels, a small amount of methanol (<20 ml) is used to allow complete transfer.

The volatile components are removed by rotary evaporation at 50° C. After cooling to ambient temperature, the mixture is desalted through a pre-packed column (HiPrep™ 26/10 Desalting MWCO 5 kDa; Cytiva) in portions (15 ml) using an AKTA start instrument running at 5 ml/min with Milli-Q water. For each 15 ml portion of nanoparticle suspension, 1.2 column volume of water used. Fractions containing nanoparticle are collected and combined. The resultant nanoparticle suspension is analysed by DLS.

### Comparative Example 1

For the purpose of comparison, a Zeba desalting column (10 mL, 7 K MWCO) was equilibrated with MiliQ water according to the manufacturer's recommendation and the reaction mixture containing the synthesised nanoparticles was loaded and spun down to collect the desalted sample.

With reference to Table 1, the diameter increase in Z average diameter for particles formed by Comparative Example 1 show aggregation of the nanoparticles over time. In contrast, there is little or no such increase for the nanoparticles treated by the method of Example 1.

Without wishing to be bound by any theory, it is believed that residual polymer chains which have not been incorporated into the nanoparticles may bind, e.g., through hydrogen bonding, to the nanoparticle surface and in this way may facilitate aggregation with other nanoparticles.

TABLE 1

| Days | Treatment method | ZAv (nm) |
|---|---|---|
| 0 | Comparative | 43.83 |
| 4 | Comparative | 43.22 |
| 12 months | Comparative | 62.3 |
| 0 | Example 1 | 43.36 |
| 12 months | Example 1 | 42.53 |

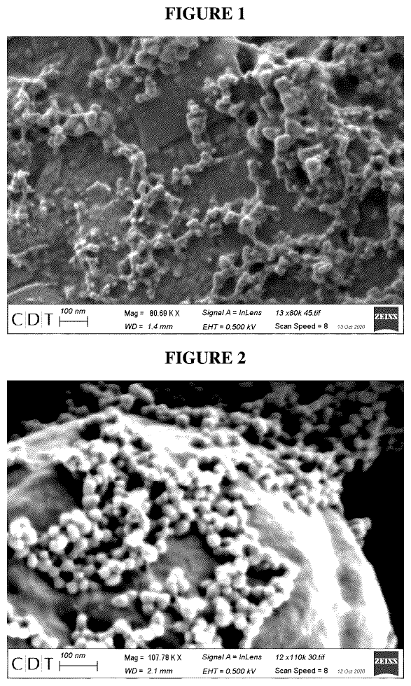

FIGS. 1 and 2 are SEM images of nanoparticles produced by the methods of Comparative Example 1 and Example 1 respectively. Polymer chains are observed on the surface of the nanoparticles of FIG. 1 whereas little or no polymer is observable in the SEM image of FIG. 2 following the treatment of Example 1.

1. A method of treating a reaction mixture comprising light-emitting nanoparticles formed upon reaction of a silica-forming compound in the presence of a light-emitting material in a protic, water-miscible solvent, the method comprising forming a phase-separated system comprising: an aqueous phase comprising the protic, water miscible solvent, an organic phase comprising an organic solvent and a separating solvent; and separating the organic phase, the separating solvent being immiscible with water, miscible with the water-miscible protic solvent and miscible with the organic solvent.

2. The method according to claim 1 wherein the separating solvent has a dielectric constant between that of the protic, water miscible solvent and the organic solvent.

3. The method according to claim 1 wherein the protic, water-miscible solvent is methanol.

4. The method according to claim 2 wherein the separating solvent is a C₅₋₂₀ alcohol.

5. The method according to claim 1 wherein the light-emitting material has a solubility in the protic, water-miscible solvent of at least 0.05 mg/ml.

6. The method according to claim 1 wherein the light-emitting material is a light-emitting polymer.

7. The method according to claim 1 wherein the silica-forming compound is an orthosilicate compound.

8. The method according to claim 6 wherein the orthosilicate compound is a C₁₋₄ alkylorthosilicate compound.

9. The method according to claim 1 wherein the organic solvent is selected from benzene substituted with one or more substituents; and C₅₋₂₀ alkanes which may be unsubstituted or substituted with one or more substituents selected from F and Cl; and mixtures thereof.

10. The method according to claim 9 wherein substituents of the benzene are selected from C₁₋₆ alkyl, C₁₋₆ alkoxy, F and Cl.

11. Light-emitting nanoparticles obtainable by a method according to claim 1.

12. A method of forming light-emitting nanoparticles comprising reacting a silica-forming compound in the presence of a light-emitting material in a protic, water-miscible solvent; forming a two-phase system comprising an aqueous phase, an organic phase comprising a water-immiscible organic solvent and a separating solvent; and separating the organic phase.
